(19) United States
(12) Patent Application Publication
(10) Pub. No.: US 2015/0271362 A1
(43) Pub. Date: Sep. 24, 2015

(54) IMAGE PROCESSING APPARATUS, IMAGE PROCESSING METHOD, AND NON-TRANSITORY RECORDING MEDIUM STORING IMAGE PROCESSING PROGRAM

(71) Applicant: Shingo SHIRAMURA, Osaka (JP)

(72) Inventor: Shingo SHIRAMURA, Osaka (JP)

(21) Appl. No.: 14/642,969

(22) Filed: Mar. 10, 2015

(30) Foreign Application Priority Data
Mar. 18, 2014 (JP) 2014-054707

(51) Int. Cl. H04N 1/387; G06K 15/02

(52) U.S. Cl. CPC H04N 1/3877; G06K 15/1842; G06K 15/1886; H04N 2201/0094

(57) ABSTRACT

An image processing apparatus includes a rotation processing unit, an output image information output unit, and a shared area generation unit. The rotation processing unit performs a rotation process on an image to generate a rotated image. The output image information output unit performs, based on the rotated image, an output image information output process of outputting output image information of an image to be output. The shared area generation unit generates a shared area in a memory in the image processing apparatus shared by the rotation process and the output image information output process. The rotation processing unit stores information of the rotated image in a region in the generated shared area. The output image information that is output in the output image information output process is stored in the region in the shared area storing the information of the rotated image.

### CROSS-REFERENCE TO RELATED APPLICATION

This patent application is based on and claims priority pursuant to 35 U.S.C. §119(a) to Japanese Patent Application No. 2014-054707, filed on Mar. 18, 2014, in the Japan Patent Office, the entire disclosure of which is hereby incorporated by reference herein.

### BACKGROUND

1. Technical Field

This disclosure relates to an image processing apparatus, an image processing method, and a non-transitory recording medium storing an image processing program, and more particularly to the use of a memory as a work area in image processing including a rotation process.

2. Related Art

With an increased tendency toward digitization of information in recent years, image processing apparatuses, such as printers and facsimile machines for use in outputting digitized information and scanners for use in digitizing documents, have been playing a significant role. Provided with functions such as imaging, image formation, and communication, such image processing apparatuses are often configured as multifunction peripherals (MFPs) usable as printers, facsimile machines, scanners, and copiers.

When such an image processing apparatus forms and outputs an image from image data with the printer function, or reads a document and outputs the read image to an external device with the scanner function, the image processing apparatus performs an image output process, which includes resolution conversion and color conversion, on the image to be output in accordance with output settings. The image processing apparatus may also perform a rotation process on the image to be output. When performing the rotation process and the image output process, the image processing apparatus secures separate areas for the two processes in a volatile memory used as a work area, which uses more of the volatile memory.

To address the increase in usage of the volatile memory, the image data may be divided into blocks of a predetermined size and subjected to the rotation process and stored in units of the divided blocks to minimize use of a storage area such as a memory used as the work area in the rotation process.

### SUMMARY

In one embodiment of this disclosure, there is provided an improved image processing apparatus that, in one example, includes a rotation processing unit, an output image information output unit, and a shared area generation unit. The rotation processing unit performs a rotation process on an image to generate a rotated image. The output image information output unit performs, based on the rotated image, an output image information output process of outputting output image information of an image to be output. The shared area generation unit generates a shared area in a memory in the image processing apparatus shared by the rotation process and the output image information output process. The rotation processing unit stores information of the rotated image in a region in the generated shared area. The output image information that is output in the output process is stored in the region in the shared area storing the information of the rotated image.

In one embodiment of this disclosure, there is provided an improved image processing performed by an image processing apparatus. The image processing method includes, in one example, performing a rotation process on an image to generate a rotated image, performing, based on the rotated image, an output image information output process of outputting output image information of an image to be output, generating a shared area in a memory in the image processing apparatus shared by the rotation process and the output image information output process, storing information of the rotated image in a region in the generated shared area, and storing the output image information that is output in the output process in the region in the shared area storing the information of the rotated image.

In one embodiment of this disclosure, there is provided a non-transitory recording medium storing an image processing program for causing an image processing apparatus to execute image processing comprising the above-described steps.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a hardware configuration of an image processing apparatus according to an embodiment of this disclosure;

FIG. 2 is a block diagram illustrating a functional configuration of the image processing apparatus according to the embodiment;

FIG. 3 is a block diagram illustrating a functional configuration of a main control unit of the image processing apparatus according to the embodiment;

FIG. 4 is a flowchart illustrating image processing according to an embodiment of this disclosure;

FIG. 5 is a diagram illustrating an example of input and output information according to an embodiment of this disclosure;

FIG. 6 is a flowchart illustrating an operation of generating a shared memory according to an embodiment of this disclosure;

FIG. 7 is a flowchart illustrating an operation of determining whether or not to generate the shared memory according to an embodiment of this disclosure;

FIG. 8 is a block diagram illustrating a configuration of a controller of the image processing apparatus according to an embodiment of this disclosure when the shared memory is not generated; and

FIG. 9 is a flowchart illustrating image processing with the configuration of the controller of the image processing apparatus according to the embodiment of this disclosure when the shared memory is not generated.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same function, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Referring now to the drawings, wherein like reference numerals designate identical or corresponding parts throughout the several views, an embodiment of this disclosure will be described in detail. In the present embodiment, a multifunction peripheral (MFP) having functions such as a printer function and a scanner function will be described as an example of an image processing apparatus.

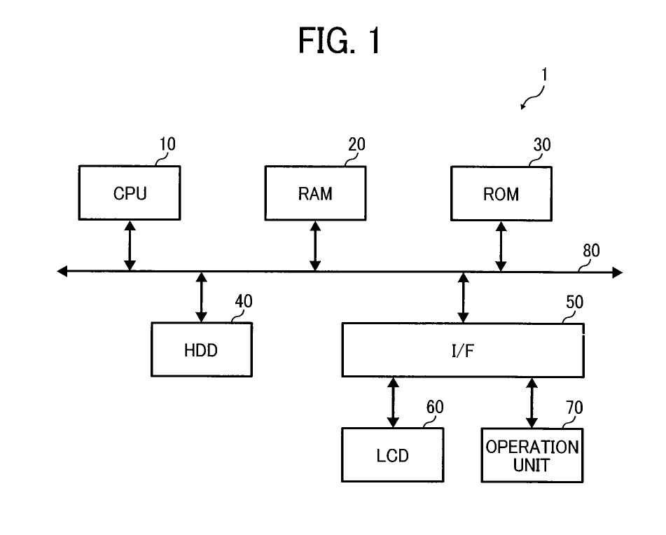

FIG. 1 is a block diagram illustrating a hardware configuration of an image processing apparatus 1 according to the present embodiment. As illustrated in FIG. 1, the image processing apparatus 1 according to the present embodiment is similar in configuration to a commonly used server or personal computer (PC).

Specifically, the image processing apparatus 1 according to the present embodiment includes a central processing unit (CPU) 10, a random access memory (RAM) 20, a read-only memory (ROM) 30, a hard disk drive (HDD) 40, and an interface (I/F) 50 connected to one another by a bus 80. The I/F 50 is connected to a liquid crystal display (LCD) 60 and an operation unit 70. The image processing apparatus 1 further includes an engine that performs formation and output of an image and an engine that performs scanning.

The CPU 10 is an arithmetic device that controls the overall operation of the image processing apparatus 1. The RAM 20 is a volatile memory capable of reading and writing information at high speed and used as a work area when the CPU 10 processes information. The ROM 30 is a non-volatile read-only memory that stores programs such firmware. The HDD 40 is a semiconductor storage device capable of reading and writing information, and stores an operating system (OS), a variety of control programs, application programs, and so forth. In the image processing apparatus 1 according to the present embodiment, an image subjected to a process such as a rotation process or a resolution conversion process is stored not in a non-volatile memory having a relatively large capacity, such as the HDD 40, but in the RAM 20.

The I/F 50 connects and controls the bus 80, a variety of hardware units, a network, and so forth. The LCD 60 is a visual user interface for allowing the status of the image processing apparatus 1 to be visually checked. The operation unit 70, which includes a keyboard, a mouse, a variety of hardware buttons, and a touch panel, is a user interface for allowing input of information to the image processing apparatus 1.

In the above-described hardware configuration, the CPU 10 serves as a software control unit by reading, in the RAM 20, programs stored in a memory such as the ROM 30, the HDD 40, or an optical disc and performing arithmetic operations in accordance with the programs. The thus-configured software control unit and hardware cooperate to form functional blocks that realize functions of the image processing apparatus 1 according to the present embodiment.

Description will now be given of the functions of the image processing apparatus 1 according to the present embodiment.

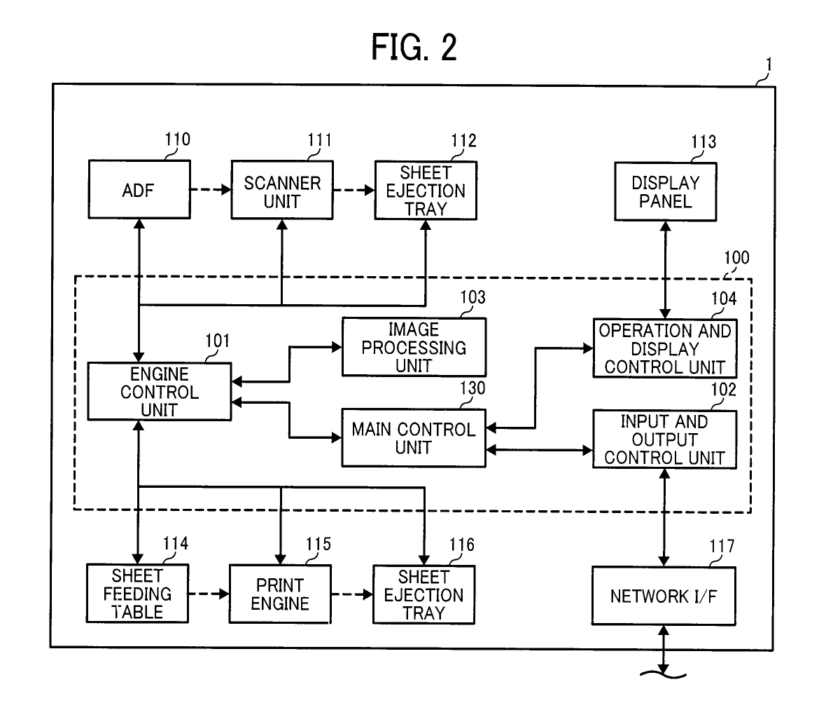

FIG. 2 is a block diagram illustrating a functional configuration of the image processing apparatus 1 according to the present embodiment. As illustrated in FIG. 2, the image processing apparatus 1 according to the present embodiment includes a controller 100, an automatic document feeder (ADF) 110, a scanner unit 111, a sheet ejection tray 112, a display panel 113, a sheet feeding table 114, a print engine 115, a sheet ejection tray 116, and a network I/F 117.

The controller 100 includes a main control unit 130, an engine control unit 101, an input and output control unit 102, an image processing unit 103, and an operation and display control unit 104.

As illustrated in FIG. 2, the image processing apparatus 1 according to the present embodiment is configured as a multifunction peripheral including the scanner unit 111 and the print engine 115. In FIG. 2, solid arrows indicate electrical connections, and broken arrows indicate flows of sheets.

The display panel 113 serves as both an output interface that visually displays the status of the image processing apparatus 1 and an input interface (i.e., an operation unit) used as a touch panel to directly operate the image processing apparatus 1 or input information to the image processing apparatus 1. The network I/F 117 is an interface for allowing the image processing apparatus 1 to communicate with an external device such as an administrator terminal via a network, and may be an interface conforming to Ethernet (a registered trademark), universal serial bus (USB), Bluetooth (a registered trademark), or wireless fidelity (Wi-Fi), for example.

The controller 100 is a combination of software and hardware. Specifically, the controller 100 is formed by hardware such as integrated circuits and the foregoing software control unit, which is configured by the CPU 10 performing arithmetic operations in accordance with control programs such as firmware stored in a non-volatile memory such as the ROM 30 or the HDD 40 and loaded to the RAM 20. The controller 100 functions as a control unit that controls the entire image processing apparatus 1.

The main control unit 130 controls the units included in the controller 100, and issues commands to the units of the controller 100. The engine control unit 101 serves as a driver that controls or drives units such as the print engine 115 and the scanner unit 111. The input and output control unit 102 inputs to the main control unit 130 signals and commands input from an information processor or the like connected to the image processing apparatus 1 via the network I/F 117. Further, the input and output control unit 102 is controlled by the main control unit 130 to access the external device via the network I/F 117.

In accordance with the control of the main control unit 130, the image processing unit 103 generates rendering information based on image information to be printed out. The rendering information is information for rendering an image that is formed in an image forming operation by the print engine 115 serving as an image forming and outputting unit.

The image processing unit 103 further processes imaging data input by the scanner unit 111 to generate image data. The image data is information transmitted to the external device via the network I/F 117 as the outcome of a scanning operation. The operation and display control unit 104 displays information on the display panel 113 or notifies the main control unit 130 of information input via the display panel 113.

When the image processing apparatus 1 operates as a printer, the input and output control unit 102 first receives a print job from the information processor or the like connected to the image processing apparatus 1 via the network I/F 117. The input and output control unit 102 transmits the received print job to the main control unit 130. The main control unit 130 having received the print job controls the image processing unit 103 to generate rendering information in bitmap format or the like based on the image information or text information in page description language (PDL) format or the like included in the print job. After the image processing unit 103 generates the rendering information, the engine control unit 101 executes image formation on a sheet (i.e., a recording medium) conveyed from the sheet feeding table 114 based on the generated rendering information by generating an image according to output setting information including the resolution and the color mode of the image to be formed and output. The print engine 115 may specifically be an inkjet image forming mechanism or an electrophotographic image forming mechanism, for example. The sheet subjected to the image formation by the print engine 115 is ejected to the sheet ejection tray 116.

When the image processing apparatus 1 operates as a scanner, i.e., an image reading control device, the operation and display control unit 104 or the input and output control unit 102 transmits a scanning execution signal to the main control unit 130 in accordance with a manual operation of the display panel 113 or a scanning execution instruction (i.e., a scan job) input from the external device via the network I/F 117. The main control unit 130 controls the engine control unit 101 based on the received scanning execution signal. The engine control unit 101 drives the ADF 110 to convey a document set thereon as an imaging target to the scanner unit 111, and then to the sheet ejection tray 112. The engine control unit 101 also drives the scanner unit 111 to image the document conveyed by the ADF 110. If the document is set not on the ADF 110 but directly on the scanner unit 111, the scanner unit 111 images the set document in accordance with the control of the engine control unit 101. That is, the scanner unit 111 operates as an imaging unit.

In the imaging operation, an imaging device such as a charge coupled device (CCD) included in the scanner unit 111 optically scans the document to generate imaging information based on optical information. The engine control unit 101 transmits the imaging information generated by the scanner unit 111 to the image processing unit 103. In accordance with the control of the main control unit 130, the image processing unit 103 generates image information based on the imaging information received from the engine control unit 101. After the image processing unit 103 generates the image information, the main control unit 130 generates image data according to output setting information, which includes the resolution and the color mode of the image data to be output to the external device, based on the generated image information. The input and output control unit 102 transmits the generated image data to the external device via the network I/F 117.

When the image processing apparatus 1 operates as a copier, the image processing unit 103 generates rendering information based on the imaging information received from the scanner unit 111 by the engine control unit 101 or the image information generated by the image processing unit 103. The engine control unit 101 then drives the print engine 115 based on the rendering information similarly to the printer operation.

The thus-configured image processing apparatus 1 reduces the usage of a memory, such as the RAM 20, used as a work area when the image processing unit 103, the engine control unit 101, and the main control unit 130 execute the above-described processes. In the image processing apparatus 1 according to the present embodiment, the image processing unit 103 performs the rotation process on the image based on the image information or the rendering information generated as described above, and stores one whole page (hereinafter referred to as one page) of image subjected to the rotation process in a storage area secured in a volatile memory such as the RAM 20 included in the image processing apparatus 1. Further, the engine control unit 101 and the main control unit 130 execute a process of storing, in the storage area secured in the volatile memory such as the RAM 20 included in the image processing apparatus 1, the information of the image generated in accordance with the output setting information based on the information of the image subjected to the rotation process (hereinafter referred to as the rotated image) by the image processing unit 103 (hereinafter referred to as the output image information).

A functional configuration of the main control unit 130 according to the present embodiment will now be described.

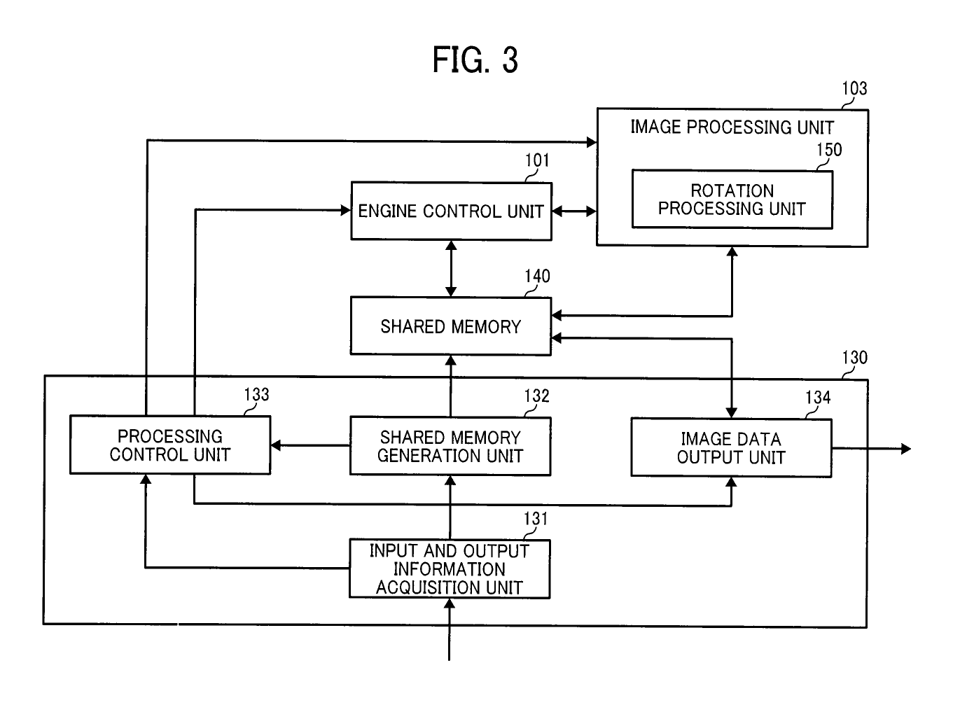

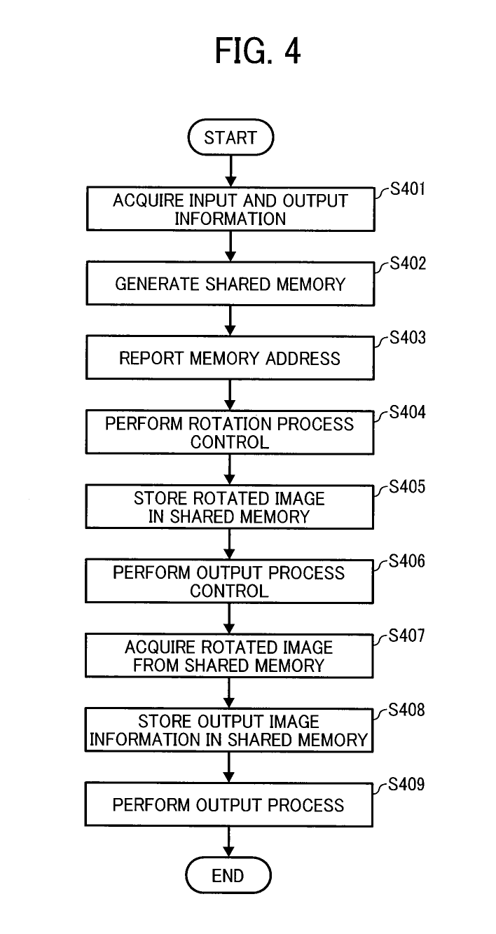

FIG. 3 is a block diagram illustrating an example of the functional configuration of the main control unit 130 according to the present embodiment. FIG. 4 is a flowchart illustrating an example of image processing by the main control unit 130 according to the present embodiment. As illustrated in FIG. 3, the main control unit 130 according to the present embodiment includes an input and output information acquisition unit 131, a shared memory generation unit 132, a processing control unit 133, and an image data output unit 134.

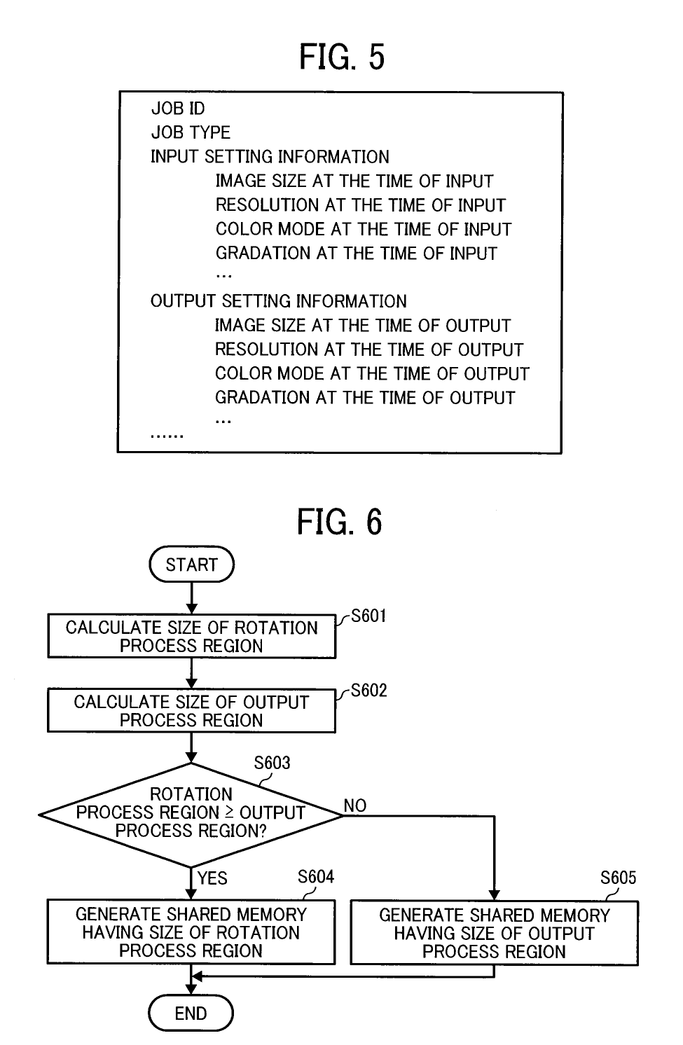

As illustrated in FIG. 4, in the main control unit 130 according to the present embodiment, the input and output information acquisition unit 131 first acquires input and output information concerning the input and output in the image processing (step S401). FIG. 5 illustrates an example of the input and output information. As illustrated in FIG. 5, the input and output information includes, for example, a job identifier (ID), job type, input setting information, and output setting information.

The job ID refers to identification information for identifying a job that the image processing apparatus 1 receives from the information processor or the like connected to the image processing apparatus 1 via the network I/F 117. The job type refers to the type of the received job, such as print job, scan job, or copy job, for example. The information of the job ID and the job type is included in, for example, the received job.

The input setting information includes, for example, the image size at the time of input, the resolution at the time of input, the color mode at the time of input, and the gradation at the time of input, and refers to setting information of the image input in the image processing. If the received job is a print job, for example, the input setting information may be acquired from information included in the job, the image information, or the text information in the PDL format or the like described above. If the received job is a scan job or the copy job, the input setting information may be acquired from information included in the job, the foregoing imaging information generated by the scanner unit 111, or setting information of the scanner unit 111.

The output setting information includes, for example, the image size at the time of output, the resolution at the time of output, the color mode at the time of output, and the gradation at the time of output, and refers to setting information of the image output in the image processing. The output setting information may be acquired from, for example, information included in the received job.

After the input and output information acquisition unit 131 acquires the input and output information, the shared memory generation unit 132 generates a shared memory 140, which is a storage area in a volatile memory of the image processing apparatus 1, based on the acquired input and output information (step S402). The shared memory 140 serves as a shared area in the volatile memory shared by, for example, the image processing unit 103, the engine control unit 101, and the image data output unit 134. That is, the shared memory generation unit 132 functions as a shared area generation unit that generates the shared area. The operation of generating the shared memory 140 will be described in detail later.

After the shared memory generation unit 132 generates the shared memory 140, the processing control unit 133 notifies the image processing unit 103, the engine control unit 101, and the image data output unit 134 of the address of the shared memory 140 in the volatile memory (step S403), thereby enabling the image processing unit 103, the engine control unit 101, and the image data output unit 134 to access the shared memory 140 and share the information stored in the shared memory 140.

The processing control unit 133, having reported the address of the shared memory 140, performs a rotation process control on the image processing unit 103 (step S404). In accordance with the rotation process control, a rotation processing unit 150 included in the image processing unit 103 performs the rotation process on the image based on the rendering information generated by the image processing unit 103, and stores one page of rotated image in the shared memory 140 (step S405).

After the rotation processing unit 150 performs the rotation process, the processing control unit 133 performs an output process control on the engine control unit 101 or the image data output unit 134 based on the input and output information acquired by the input and output information acquisition unit 131 (step S406). Specifically, if the job type included in the input and output information is a print job or a copy job, for example, the processing control unit 133 performs the output process control on the engine control unit 101 that controls the print engine 115 to execute image output.

In accordance with the output process control, the engine control unit 101 acquires the rotated image stored in the shared memory 140 (step S407), and performs processes such as resolution conversion and color conversion on the acquired rotated image to obtain the image size, resolution, color mode, and gradation at the time of output included in the output setting information in the input and output information. Thereby, the output image information, i.e., the information of the image to be formed and output, is generated.

If the job type included in the input and output information is a scan job, for example, the processing control unit 133 performs the output process control on the image data output unit 134 of the main control unit 130 that causes the input and output control unit 102 to transmit the image data to the external device via the network I/F 117. With this output process control, the image data output unit 134 acquires the rotated image stored in the shared memory 140 (step S407), and performs processes such as resolution conversion and color conversion on the acquired rotated image to obtain the image size, resolution, color mode, and gradation at the time of output included in the output setting information in the input and output information. Thereby, the output image information, i.e., image data to be transmitted to the external device, is generated.

The output image information generated by the output process control at step S406 is stored in the shared memory 140 having stored the rotated image (step S408). Thereby, the output image information is written in the same region of the shared memory 140 having stored the rotated image. Specifically, for example, in accordance with a read command from the CPU 10 that controls the engine control unit 101 and the image data output unit 134 that generate the output image information, the data at the address in the shared memory 140 notified at step S403 is sequentially read and stored in a cache of the CPU 10. Then, the output image information is generated based on the data stored in the cache and written at the same address of the read data, i.e., written over the read data, in accordance with a write command from the CPU 10.

If the shared memory 140 storing the rotated image has an unused open region (e.g., a region corresponding to one dot of image), the read data may be stored in the unused region in the shared memory 140 in place of the cache of the CPU 10.

If the engine control unit 101 generates the output image information, the engine control unit 101 controls the print engine 115 to perform an output process of executing image formation on a sheet based on the generated output image information (step S409). If the image data output unit 134 generates the output image information, the image data output unit 134 outputs the image data, i.e., the generated output image information, to the input and output control unit 102 to perform an output process of transmitting the image data to the external device via the network I/F 117 (step S409). That is, each of the engine control unit 101 and the image data output unit 134 functions as an output image information output unit that performs an output image information output process of outputting the output image information, i.e., the information of the image to be output.

A detailed description will now be given of the operation of generating the shared memory 140.

FIG. 6 is a flowchart illustrating an example of the operation of generating the shared memory 140. As illustrated in FIG. 6, the shared memory generation unit 132 calculates the size of a region in the volatile memory of the image processing apparatus 1 necessary for storing one page of rotated image subjected to the rotation process by the rotation processing unit 150 included in the image processing unit 103 (hereinafter referred to as the rotation process region) (step S601).

Specifically, for example, the shared memory generation unit 132 calculates the size of the rotated image based on the image size, resolution, color mode, and gradation at the time of input included in the input setting information in the input and output information acquired by the input and output information acquisition unit 131, and uses the calculated size of the rotated image as the size of the rotation process region. Alternatively, the size of the rotation process region may be somewhat larger than the size of the rotated image, such as twice as large as the size of the rotated image, for example. If the size of the rotated image is smaller than a predetermined threshold size, the size of the rotation process region may be set to the threshold size.

The shared memory generation unit 132 further calculates the size of a region in the volatile memory of the image processing apparatus 1 necessary for storing the output image information generated by the engine control unit 101 or the image data output unit 134 (hereinafter referred to as the output process region) (step S602). There is no fixed order between the process of step S601 and the process of step S602. The two steps may therefore be performed in reverse order or in parallel.

Specifically, for example, the shared memory generation unit 132 calculates the size of the output image based on the image size, resolution, color mode, and gradation at the time of output included in the output setting information in the input and output information acquired by the input and output information acquisition unit 131, and uses the calculated size of the output image as the size of the output process region. Alternatively, the size of the output process region may be somewhat larger than the size of the output image, such as twice as large as the size of the output image, for example. If the size of the output image is smaller than a predetermined threshold size, the size of the output process region may be set to the threshold size.

After the calculation of the size of the rotation process region and the size of the output process region, if the calculated size of the rotation process region equals or exceeds the calculated size of the output process region (YES at step S603), the shared memory generation unit 132 generates the shared memory 140 by securing a storage area having the size of the rotation process region in the volatile memory of the image processing apparatus 1 (step S604).

If the calculated size of the rotation process region is smaller than the calculated size of the output process region (NO at step S603), the shared memory generation unit 132 generates the shared memory 140 by securing a storage area having the size of the output process region in the volatile memory of the image processing apparatus 1 (step S605).

As described above, in the image processing apparatus 1 according to the present embodiment, the shared memory 140, i.e., the storage area shared by the image processing unit 103, the engine control unit 101, and the main control unit 130, is generated in the volatile memory of the image processing unit 1 to store one page of rotated image subjected to the rotation process by the rotation processing unit 150. Further, the output image information generated by the engine control unit 101 or the image data output unit 134 based on the rotated image stored in the shared memory 140 is stored in the same region in the shared memory 140 storing the information of the rotated image. Thereby, the image processing unit 103 (specifically, the rotation processing unit 150), the engine control unit 101, and the image data output unit 134 are allowed to store both the rotated image and the output image in a shared storage area, without separately securing a storage area for storing one page of rotated image and a storage area for storing the output image information. In the image processing apparatus 1 that stores one page of rotated image in the memory used as the work area in image processing, therefore, the usage of the memory as the work area is reduced.

The present embodiment is useful when, for example, it is necessary to store one whole page of rotated image in the volatile memory, without dividing the image data into blocks, due to the specifications of software or hardware provided to the image processing apparatus 1. The present embodiment is also useful when, for example, the image processing apparatus 1 distributing the image data real-time to the external device via a network needs to store one whole page of image to be distributed in the volatile memory to avoid a situation in which image input fails to catch up with image distribution due to the image data distribution speed being faster than the speed of inputting the distribution image.

In the foregoing embodiment, a description has been given of an example in which the engine control unit 101 or the image data output unit 134 generates the output image information by performing processes such as resolution conversion on the rotated image stored in the shared memory 140 in accordance with the output process control, and writes the generated output image information in the same region in the shared memory 140 storing the information of the image-processed image, i.e., writes the output image information over the information of the image-processed image. Alternatively, the engine control unit 101 or the image data output unit 134 may directly output the information of the rotated image stored in the shared memory 140 to the print engine 115 or the input and output control unit 102 as the output image information in accordance with the output process control. Also in this case, it is possible to perform the image output process without securing a page memory for storing the image to be output to the print engine 115 or the input and output control unit 102 separately from a memory for storing the rotated image. In the image processing apparatus 1 that stores one page of rotated image in the volatile memory, therefore, the usage of the volatile memory is reduced.

Further, in the foregoing embodiment, the description has been given of an example in which the shared memory 140 is generated in a volatile memory such as the RAM 20. However, this is only one example, and thus the shared memory 140 may be generated in a memory having a relatively small capacity and usable as the work area but capable of high-speed information reading and writing, such as a solid state drive (SSD), which is a semiconductor storage device.

Further, in the foregoing embodiment, a description has been given of an example in which the shared memory 140 is generated regardless of the type of the image that is processed. Alternatively, whether or not to generate the shared memory 140 may be determined in accordance with the job (an image processing request), i.e., the image to be processed and the process.

An operation in which the shared memory generation unit 132 determines whether or not to generate the shared memory 140 will now be described.

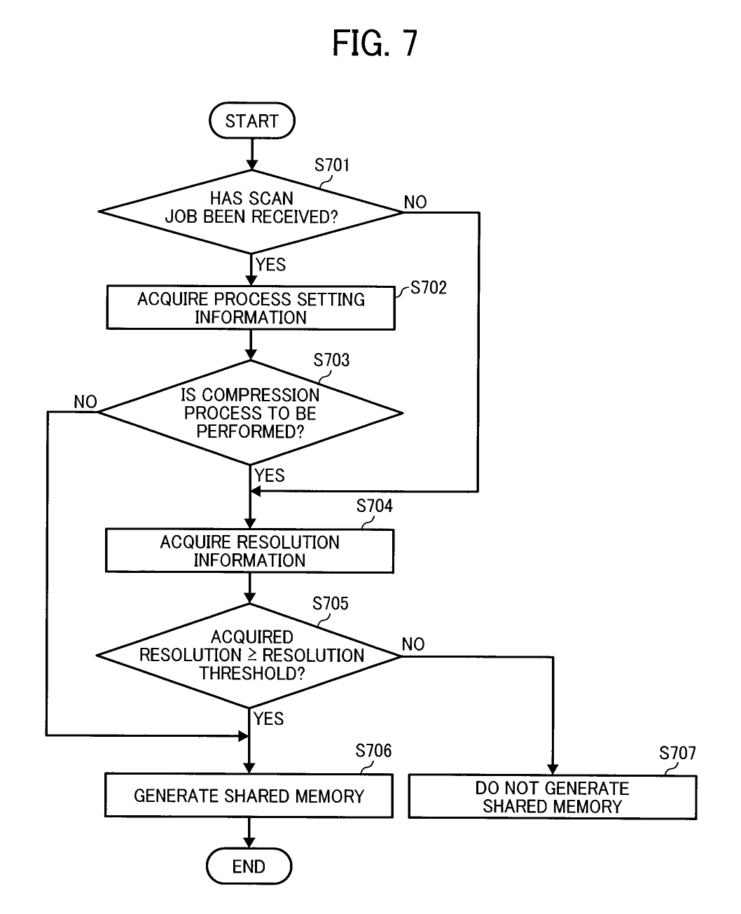

FIG. 7 is a flowchart illustrating an example of the operation of determining whether or not to generate the shared memory 140. As illustrated in FIG. 7, the shared memory generation unit 132 determines whether or not the job type in the input and output information acquired by the input and output information acquisition unit 131 is a scan job (step S701). If the job type is a scan job (YES at step S701), the shared memory generation unit 132 acquires process setting information (step S702).

The process setting information is setting information for the execution of the scanning process based on a scan job. For example, the process setting information includes a compression mode indicating whether or not to perform a compression process in the generation of the imaging information by the scanner unit 111. For instance, YES as the value of the compression mode indicates that the compression process is to be performed, and NO as the value of the compression mode indicates that the compression process is not to be performed. The process setting information may be included in the input and output information, or may be acquired from the setting information controlled by the scanner unit 111, for example.

After the acquisition of the process setting information, if the compression mode included in the acquired process setting information indicates that the compression process is not to be performed (NO at step S703), the shared memory generation unit 132 generates the shared memory 140 (step S706). If the compression mode indicates that the compression process is to be performed (YES at step S703), the shared memory generation unit 132 acquires resolution information (step S704). The resolution information is the resolution at the time of output included in the input and output information acquired by the input and output information acquisition unit 131.

After the acquisition of the resolution information, if the acquired resolution information equals or exceeds a predetermined resolution threshold, e.g., 300 dots per inch (dpi) (YES at step S705), the shared memory generation unit 132 generates the shared memory 140 (step S706). If the acquired resolution information falls below the resolution threshold (NO at step S705), the shared memory generation unit 132 determines not to generate the shared memory 140 (step S707).

That is, when the job received by the image processing apparatus 1 is a scan job, the shared memory generation unit 132 does not generate the shared memory 140 if the compression process is to be performed in the generation of the imaging information by the scanner unit 111, and if the resolution at the time of output falls below the resolution threshold. When the job received by the image processing apparatus 1 is other than a scan job, the shared memory generation unit 132 does not generate the shared memory 140 if the resolution at the time of output falls below the resolution threshold.

The resolution threshold is set in accordance with, for example, the input resolution of the scanner unit 111. The upper limit of the size of the volatile memory of the image processing apparatus 1 is set to, for example, twice the memory capacity according to the input resolution. For example, if the resolution threshold is set to 300 dpi when the input resolution is 300 dpi, and if the resolution at the time of output falls below the resolution threshold, there is no excess over the size limit of the volatile memory.

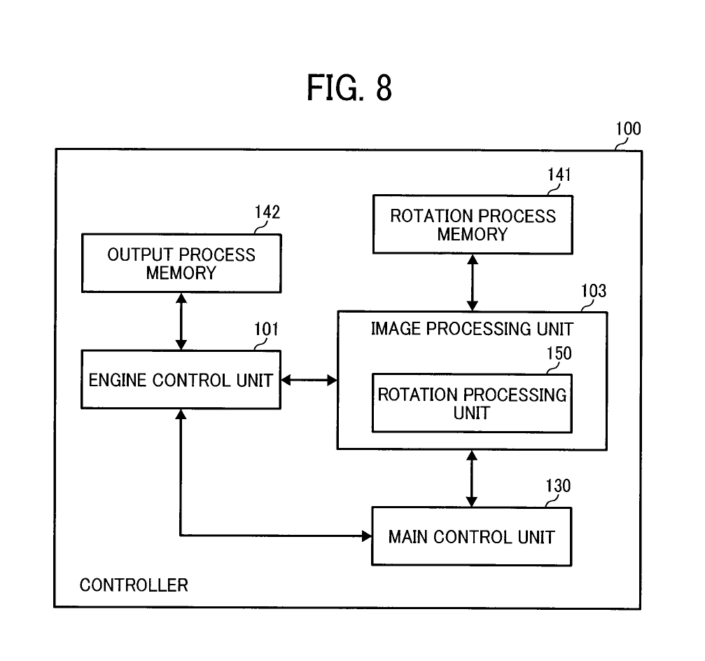

FIG. 8 is a diagram illustrating an example of the configuration of the controller 100 when the shared memory generation unit 132 does not generate the shared memory 140. FIG. 8 only illustrates components relating to the embodiment in which the shared memory 140 is not generated, and other unrelated components are omitted in the drawing. Further, the following describes an example in which the engine control unit 101 performs the process of generating the output image information.

As illustrated in FIG. 8, the image processing unit 103 secures a rotation process memory 141, i.e., a special storage area for storing the rotated image, in the volatile memory in accordance with the control of the main control unit 130.

The engine control unit 101 further secures, separately from the rotation process memory 141, an output process memory 142, i.e., a special storage area for storing the output image information, in the volatile memory in accordance with the control of the main control unit 130. In this case, the rotation process memory 141 is only accessible to the image processing unit 103, and the output process memory 142 is only accessible to the engine control unit 101. The respective sizes of the rotation process memory 141 and the output process memory 142 may be calculated by the processes of steps S601 and S602 described with reference to FIG. 6.

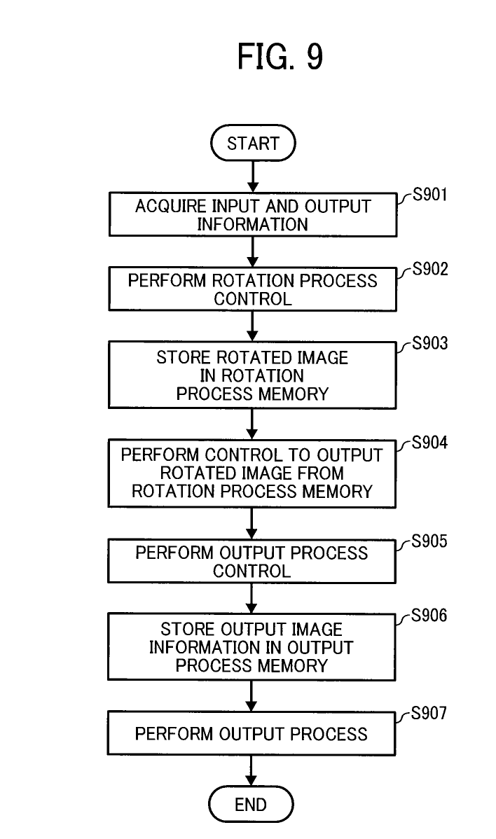

FIG. 9 is a flowchart illustrating an example of image processing according to the configuration illustrated in FIG. 8. As illustrated in FIG. 9, the main control unit 130 first acquires the input and output information similarly to the process of step S401 (step S901). After the acquisition of the input and output information, the main control unit 130 performs the rotation process control on the image processing unit 103 similarly to the process of step S404 (step S902). In accordance with the rotation process control, the rotation processing unit 150 included in the image processing unit 103 performs the rotation process on the image based on the rendering information generated by the image processing unit 103, and stores one page of rotated image in the rotation process memory 141 (step S903).

After the rotation process by the rotation processing unit 150, the main control unit 130 controls the image processing unit 103 to output the rotated image stored in the rotation process memory 141 (step S904). In accordance with the control to output the rotated image, the rotated image stored in the rotation process memory 141 is output to the engine control unit 101.

After the control to output the rotated image, the main control unit 130 performs the output process control on the engine control unit 101 similarly to the process of step S406 (step S905). In accordance with the output process control, the engine control unit 101 generates the output image information based on the rotated image input from the rotation processing unit 150. The engine control unit 101 having generated the output image information stores the generated output image information in the output process memory 142 (step S906). Further, the engine control unit 101 controls the print engine 115 to perform the output process of executing image formation on a sheet based on the generated output image information (step S907).

As described above, when the job received by the image processing apparatus 1 is a scan job, the shared memory generation unit 132 does not generate the shared memory 140 if the compression process is to be performed in the generation of the imaging information by the scanner unit 111, and if the resolution at the time of output falls below the resolution threshold. Further, when the job received by the image processing apparatus 1 is other than a scan job, the shared memory generation unit 132 does not generate the shared memory 140 if the resolution at the time of output falls below the resolution threshold.

In the above case in which the received job is a scan job, if the compression process is performed in the generation of the imaging information by the scanner unit 111, the size of the imaging information is usually substantially smaller than that in a case in which the compression process is not performed. Therefore, respective sizes of the image information, the rotated image, and the output image information generated based on the generated imaging information are also very small. Further, if the resolution at the time of output falls below the resolution threshold, the size of the output image information is very small. Accordingly, the usage of the volatile memory is unlikely to dramatically increase even if the storage area for storing the rotated image and the storage area for storing the output image information are separately secured in the volatile memory.

When the received job is a scan job, the presence or absence of the compression process is determined for the following reason. That is, in the present embodiment, the image data generated by the scanning process is stored not in a non-volatile memory such as an HDD but in a volatile memory until the transmission of the image data to the external device is completed, and thus whether or not to perform the compression process significantly affects the size of the storage area for storing the image data to be transmitted. However, whether or not to generate the shared memory 140 may be determined based on whether or not the compression process is to be performed, without identifying the received job.

With the above-described configuration, whether or not to generate the shared memory 140 is determined in advance in accordance with the usage of the volatile memory estimated based on the image to be processed and the process, allowing efficient image processing in consideration of the processing load in the case in which the shared memory 140 is generated (e.g., the process of generating the shared memory 140 and the process of notifying of the address of the shared memory 140) and the processing load in the case in which the shared memory 140 is not generated (e.g., the increase in usage of the storage area).

In the foregoing embodiment, a description has been given of an example in which the rotation processing unit 150 performs the rotation process. Alternatively, if the image processing apparatus 1 receives a job not involving rotation, the shared memory generation unit 132 may determine whether or not the job received by the image processing apparatus 1 includes the rotation process and generate the shared memory 140 if the job includes the rotation process.

Also in the above-described modified examples, the shared memory 140 may be generated not only in a volatile memory but also in a memory having a relatively small capacity and usable as the work area but capable of high-speed information reading and writing, such as an SSD, which is a semiconductor storage device.

According to an embodiment of the present disclosure, in an image processing apparatus that stores one page of rotated image in a memory used as a work area in image processing, the usage of the memory as the work area is reduced.

The above-described embodiments are illustrative and do not limit this disclosure. Thus, numerous additional modifications and variations are possible in light of the above teachings. For example, elements or features of different illustrative and embodiments herein may be combined with or substituted for each other within the scope of this disclosure and the appended claims. Further, features of components of the embodiments, such as number, position, and shape, are not limited to those of the disclosed embodiments and thus may be set as preferred. Further, the above-described steps are not limited to the order disclosed herein. It is therefore to be understood that, within the scope of the appended claims, this disclosure may be practiced otherwise than as specifically described herein.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any memory for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. An image processing apparatus comprising:
a rotation processing unit to perform a rotation process on an image to generate a rotated image;
an output image information output unit to perform, based on the rotated image, an output image information output process of outputting output image information of an image to be output; and
a shared area generation unit to generate a shared area in a memory in the image processing apparatus shared by the rotation process and the output image information output process,
wherein the rotation processing unit stores information of the rotated image in a region in the generated shared area, and
wherein the output image information that is output in the output image information output process is stored in the region in the shared area storing the information of the rotated image.

2. The image processing apparatus according to claim 1, wherein the output image information output unit generates the output image information based on the information of the rotated image stored in the region in the shared area, and writes the generated output image information over the information of the rotated image stored in the region in the shared area.

3. The image processing apparatus according to claim 1, wherein the output image information output unit outputs the information of the rotated image stored in the region in the shared area as the output image information.

4. The image processing apparatus according to claim 1, wherein the shared area generation unit generates the shared area having a size determined in accordance with a size of a region in the memory for storing the rotated image and a size of a region in the memory for storing the output image information.

5. The image processing apparatus according to claim 1, wherein the shared area generation unit determines whether or not to generate the shared area based on a received image processing request.

6. The image processing apparatus according to claim 5, wherein the shared area generation unit generates the shared area if a compression process is not to be performed on an image that is processed based on the received image processing request.

7. The image processing apparatus according to claim 5, wherein the shared area generation unit generates the shared area if a resolution of an image that is processed based on the received image processing request exceeds a predetermined threshold.

8. An image processing method performed by an image processing apparatus, comprising:
performing a rotation process on an image to generate a rotated image;
performing, based on the rotated image, an output image information output process of outputting output image information of an image to be output;
generating a shared area in a memory in the image processing apparatus shared by the rotation process and the output image information output process;
storing information of the rotated image in a region in the generated shared area; and
storing the output image information that is output in the output image information output process in the region in the shared area storing the information of the rotated image.

9. A non-transitory recording medium storing an image processing program for causing an image processing apparatus to execute image processing comprising:
performing a rotation process on an image to generate a rotated image;
performing, based on the rotated image, an output image information output process of outputting output image information of an image to be output;
generating a shared area in a memory in the image processing apparatus shared by the rotation process and the output image information output process;
storing information of the rotated image in a region in the generated shared area; and
storing the output image information that is output in the output image information output process in the region in the shared area storing the information of the rotated image.
